(19) United States
(12) Patent Application Publication
(10) Pub. No.: US 2010/0100876 A1
(43) Pub. Date: Apr. 22, 2010

(54) Wireless device provisioning hardware tool

(75) Inventors: Matt Glover, Coppell, TX (US); Iain Shigeoka, Richardson, TX (US)

Correspondence Address: DOCKET CLERK, P.O. DRAWER 800889, DALLAS, TX, 75380, US

(73) Assignee: Enfora, Inc., Richardson, TX (US)

(21) Appl. No.: 12/288,588

(22) Filed: Oct. 21, 2008

(51) Int. Cl. G06F 9/445

(52) U.S. Cl. 717/178

(57) ABSTRACT

Systems and methods are disclosed for provisioning a position monitoring device. The position monitoring device may include a wireless communication modem and a first serial port. A provisioning device may be coupled to the position monitoring device through a serial connection. The provisioning device can include a memory, a second serial port, and a processor. In some embodiments, the provisioning device initiates an automatic configuration of the wireless communication modem through a series of attention commands.

### TECHNICAL FIELD

Generally, the invention relates to devices with updateable operating parameters, and, more particularly, the invention relates to automating the update of device parameters.

### BACKGROUND

The present disclosure relates to programming or configuring machine-to-machine (M2M) wireless capable devices. One example of such an M2M wireless device is a Global Positioning System (GPS) tracking device that has the ability to transmit GPS data over a wireless network. GPS data is used to determine the exact location of the M2M wireless device. In one specific example, the GPS tracking device includes a location/position module (for determining location/position information such as GPS data) and a wireless communications modem or radio (e.g., a Global System for Mobile/General Packet Radio Service (GSM/GPRS) module) to transmit the location information (e.g., GPS data) to a remote communications device (e.g., host server). Through the combination of such a GPS module and the GSM/GPRS module, the GPS tracking device can both obtain GPS data as well as transmit the GPS data wirelessly to the remote server. Various GPS tracking devices are available from Enfora, Inc. (Richardson, Tex.) under different part/model numbers, including GSM 2228, GSM 2218 and GSM 2238.

Typically, GPS tracking devices including GSM/GPRS modules are manually programmed or configured either at a factory or in the field. This manual programming may be referred to as “provisioning.” This provisioning may include the programming or initialization of network parameters, such as GSM/GPRS specific settings relating to the network to which the modem is to communicate, as well as operating parameters, such as settings or programming relating to information the GPS tracking device is to report and/or collect, and where to report the information. Examples of such operating parameters may include, but are not limited to, the identification of what information to report and the frequency of those reports.

One of the problems with provisioning of the GPS tracking device is that it requires a series of highly specific commands. To make things even more complicated, M2M devices usually do not include a display that allows a user to monitor the highly specific commands or a user interface (e.g., keyboard) for inputting commands. This combination of difficulty in the programming of the device and lack of an interface has generally resulted in the need for a highly trained technician to be deployed in order to provision the M2M device. In addition, this difficulty in programming introduces the possibility of errors into the provisioning of the M2M device that may render it useless.

M2M devices are generally deployed in the field to monitor a moving object (e.g., truck, container, package, etc.) Having a technician provision an M2M device is expensive, time consuming, and requires the allocation of significant human resources. In addition, should the device require provisioning in the field, a technician will either need to be deployed to the location of the device or the device needs to be removed from the tracked object and sent to the factory or other location for provisioning. Further, in the event the M2M device needs to be re-provisioned, or updated, the technician will need to manually repeat the process.

Therefore, there is a need to be able to reliably provision an M2M device (such as a GPS tracking device) without requiring that a trained technician perform the provisioning.

### SUMMARY

In one embodiment, systems and methods are disclosed for provisioning a position monitoring device. The position monitoring device includes a wireless communication modem and a first serial port. A provisioning device is coupled to the position monitoring device through a serial connection and includes a memory, a second serial port, and a processor. The A provisioning device initiates an automatic configuration of the wireless communication modem through a series of attention commands.

In another embodiment, an apparatus includes a memory that stores a plurality of commands to configure a wireless modem, a processor that accesses the memory to execute the plurality of commands to configure the wireless mode, and a serial port. The serial port is used to connect to the wireless modem and detects the connection of a target device to the serial port. The serial port is also used to automatically configure the target device using the plurality of commands stored in the memory executed by the processor.

In yet another method, a method of configuring a wireless modem includes connecting a target device to an update device, applying power to the target device, wherein the target device includes a wireless modem and does not have a user interface. This method also includes verifying the manufacturer of the target device, restoring the default settings to the target device, storing configuration data on the target device, and rebooting the target device.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram illustrating one system of implementing an automated M2M update system (AMUS);

FIG. 2 is a block diagram illustrating one system of implementing a serial AMUS that performs hardware provisioning;

FIG. 3 is a flowchart of performing hardware provisioning using AMUS;

FIG. 4 is a block diagram illustrating one system of implementing a wireless AMUS that performs software provisioning;

FIG. 5 is a flowchart of performing a wireless software provisioning using AMUS;

FIG. 6 is a diagram of a base station controller that can be used to provide data for a wireless configuration update using AMUS;

FIG. 7 is a block diagram of an exemplary general-purpose computer system suitable for implementing the several embodiments of the disclosure; and

FIG. 8 is a diagram of an exemplary hardware provisioning device.

### DETAILED DESCRIPTION

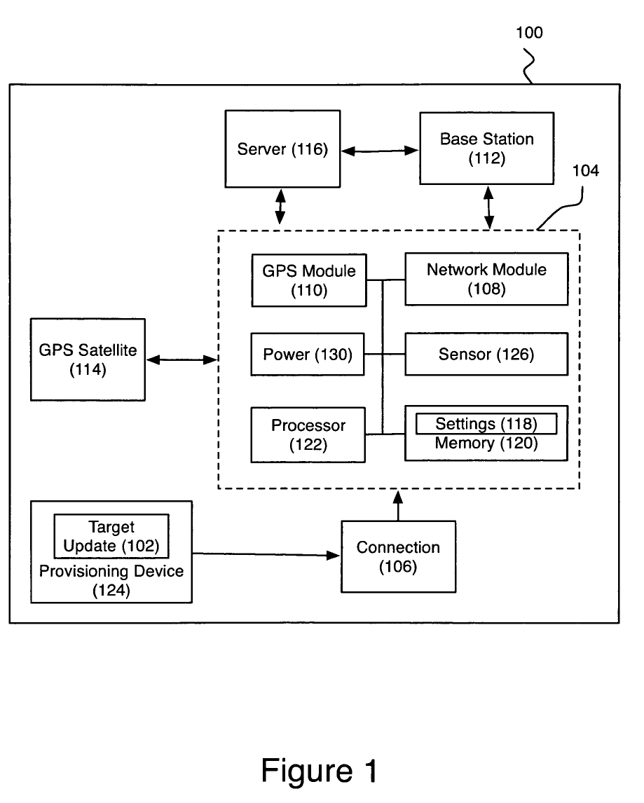

FIG. 1 is a block diagram illustrating one system of implementing an automated M2M update system (AMUS) 100. The AMUS 100 includes a GPS tracking device 104 and a provisioning device 124. The GPS tracking device 104 includes a processor 122, a wireless network module 108 (such as a GSM/GPRS/EDGE modem), a GPS module 110, one or more sensors 126, memory 120, and a power source 130, such as a battery. The memory 120 may includes store various settings 118. The GPS tracking device 104 may include a real-time clock and other components for providing additional functionality. The one or more sensors 126 may include sensors that measure/sense motion, temperature, velocity, presence or absence of a particular element, or include other functionality for performing any other task.

The AMUS 100 may also include various remote communications devices, such as a base station 112 and a host server 116. The physically separate provisioning device (tool) 124 transfers a provisioning information update 102 (or target update 102) to the GPS tracking device 104 through a connection 106. It will be understood that in one embodiment, the GPS tracking device 104 does not include a user interface.

The GPS module 110 receives satellite communications from one or more GPS satellites 114 and calculates GPS position/location information. In a different embodiment, other location determining modules may be used, such as one that calculates position/location information using a method other than GPS satellites, such as position triangulation using one or more base stations or other reference points. The wireless network module 108 provides wireless communication functionality between the GPS tracking device 104 and the base station 112 and/or host server 116, including transmitting position/location information, such as GPS data, to a remote device (e.g., host server 116).

In one embodiment, provisioning of the GPS tracking device using the provisioning device 124 via connection 106 may be referred to as “hardware provisioning” (or referred to as “wired provisioning”). In another embodiment, the provisioning device 124 may be integrated with, or its functions are performed by, the host server 116 with the target update 102 originating therefrom. This may be referred to as “software provisioning” (or referred to as “wireless provisioning”). Software provisioning may be carried out through a virtual serial connection. A virtual serial connection is where a serial connection is simulated through a parallel interface (e.g., a serial connection is simulated through a TCP/IP connection by creating a virtual serial connection in between a source and a destination).

The target update 102, when transferred, operates to provision the GPS tracking device 104 and is transferred to the GPS tracking device 104 through the connection 106. For provisioning (i.e., updating), the target update 102 includes one or more specific attention (AT) commands stored in the provisioning device 124. In response to receiving the target update 102, the GPS tracking device 104 performs one or more actions in accordance with the AT command(s) thereby provisioning the GPS tracking device 104. It will be understood that target update 102 may be downloaded entirely at one time or in portions at different times (e.g., each AT command or a group of commands is downloaded and the GPS tracking device 104 performs action(s) in response thereto prior to downloading the next command(s)).

As will be appreciated, the AT command(s) may be generated and stored within the provisioning device 124 using any means or methods. This may be accomplished using a separate programming device (not shown), such as a more complex computer or similar device via a hardwire connection to the provisioning device 124. In another example embodiment, the target update 102 may be stored in the provisioning device 124 using a pre-programmed integrated circuit (IC) or other memory device inserted or plugged into the GPS tracking device 104 (such as a PROM, EPROM, USB memory device, etc.).

Because GPS tracking device 104 is an M2M device that does not usually include a user interface, from a logistics and device management perspective, this forces each GPS tracking device 104 to be “touched” by a technician. The AMUS 10 overcomes this problem through the automated hardware provisioning device 124 (a separate device physically attached to the GPS tracking device 104) and/or through an automated software provisioning system in which the provisioning device 124 forms part of an external system that wirelessly transfers the target update 102 to the GPS tracking device 104.

Automated hardware and software provisioning removes the requirement that a skilled technician perform the setup, maintenance, or other update of GPS tracking device 104 and simplifies the setup, maintenance or other update. After provisioning, the GPS tracking device 104 may communicate with the base station 112, the server 116 (directly or through the base station 112), or any other network device through the wireless network module 108. In addition, the GPS tracking device 104 may report information acquired from the GPS satellite(s) 114 obtained through the GPS module 110 to the server 116.

Provisioning the GPS tracking device 104 can include initializing (or re-initializing) network setup parameters, updating the configuration of operating parameters and software within the device and/or altering the hardware configuration of the device. For instance, the target update 102 through the AMUS 100 may alter various network-related and device parameters, settings, firmware or software of the GPS tracking device 104 (collectively referred to “operating parameters”), including network setup parameters (“network setup parameters”), as well as device function operating parameters and settings, software updates (firmware, operating system, applications) and hardware updates (collectively, “device operating parameters”).

Network setup parameters may include information relating to wireless access point nodes (APN), domain name server (DNS), or other information use to promote wireless communications between GPS tracking device 104 through wireless network module 108 and other remote devices (e.g., base station 112, host server 116 and the like).

Device function operating parameters and settings may include parameters related to the main functioning of the GPS tracking device 104 as a GPS tracking device, such as times and frequency of transmission of GPS data, triggers, power issues, alerts, number of GPS satellites required to obtain position fix, and other parameters or settings. This may include power settings of the device (e.g. when the device will go to sleep or wake up), settings related to hardware activities (e.g., acquisition of a minimum number satellites for GPS location fixes), and hardware modem settings (e.g. hardware initialization settings). Other operating parameters may include what information is to be reported and the destination of the reporting. It is expressly understood that target update 102 may alter any parameters or settings of the GPS tracking device that are programmable or otherwise modifiable.

Software updates may include modifications or updates (including new or deleted software) to the current firmware, operating system software or application software utilized by the GPS tracking device 104. This may include application software stored locally on the GPS tracking device 104 as well as applications stored remotely and accessed through the wireless network module 108, and operating system software or firmware that controls hardware in the GPS tracking device 104.

Hardware updates may include modifications or updates to the physical hardware or functional devices within the GPS tracking device 104. One example would be programming an FPGA device or other hardware programmable or configurable device.

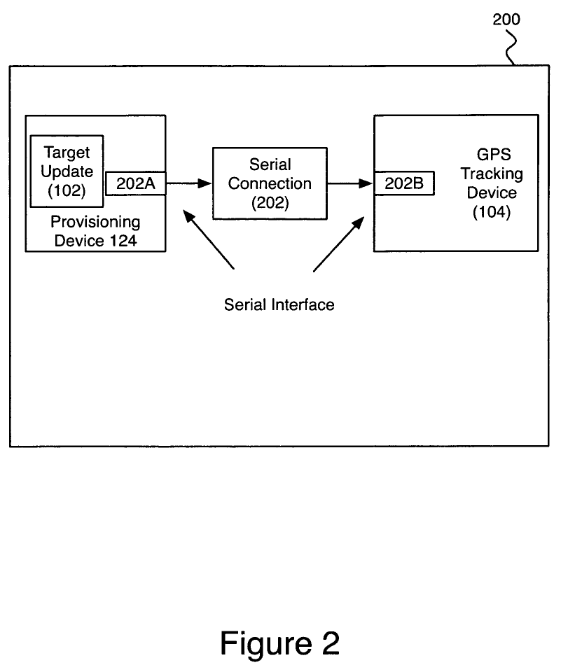

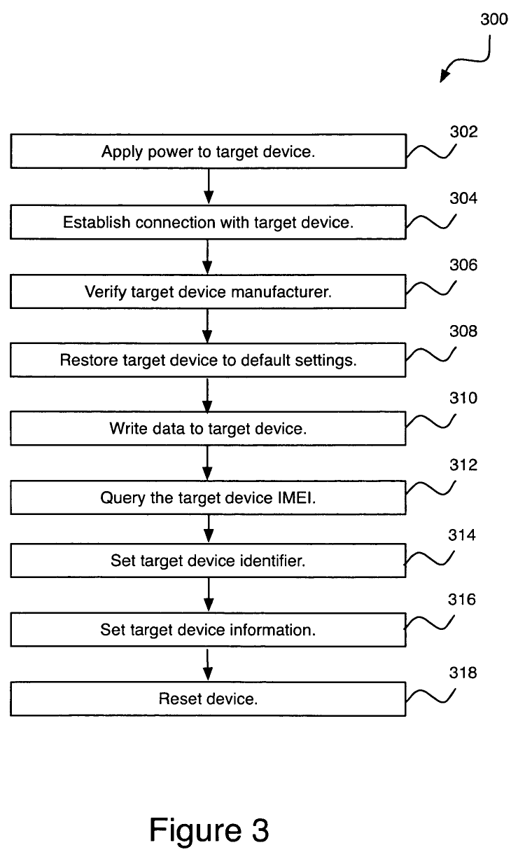

In one embodiment of the AMUS 100, provisioning is performed through automated hardware provisioning. Automated hardware provisioning utilizes the hardware provisioning device 124, such as a Universal Serial Bus (USB), serial, or other hardware device to perform an actual update to the GPS tracking device 104. This embodiment of the AMUS 100 utilizes a physical connection between the GPS tracking device 104 and the automated hardware-provisioning device 124. When connected, the automated hardware provisioning device 124 sends commands (e.g., the target update 102) to the GPS tracking device 104, and these commands provision the GPS tracking device 104 by adding, deleting or otherwise modifying its operating parameters. It is understood that the hardware provisioning device 124 may include one or more buttons that, when activated, causes the hardware provisioning device 124 to automatically provision the GPS tracking device 104 by downloading the target update 102. FIGS. 2 and 3 describe one embodiment of automated hardware provisioning.

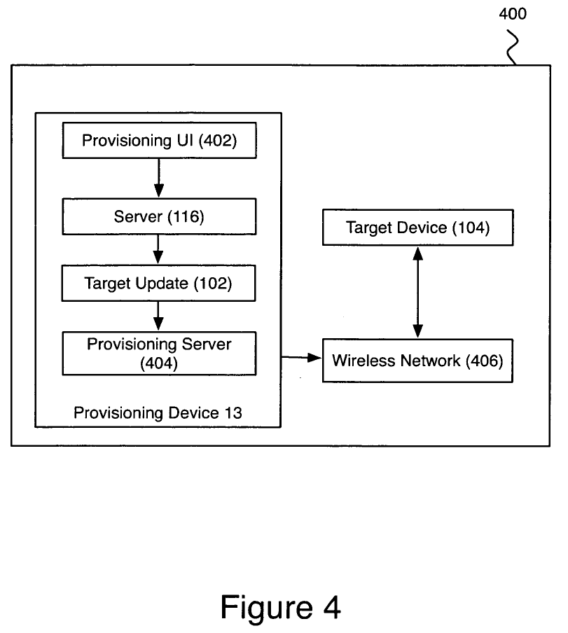

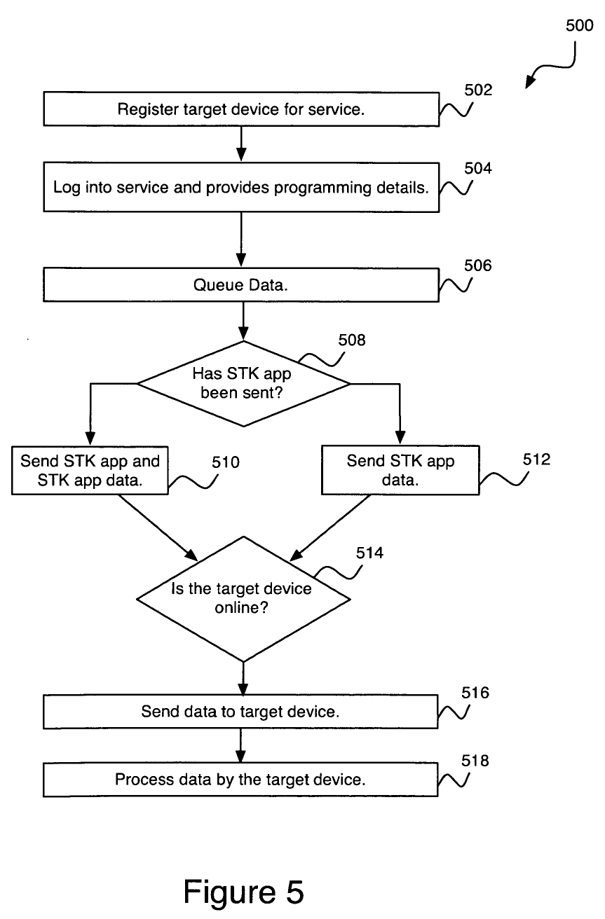

In another embodiment of AMUS 100, provisioning is performed through automated software provisioning. Automated software provisioning transfers the target update 102 through a wireless network connection via the wireless network to provision the GPS tracking device 104. In the embodiment shown in FIG. 1, the host server 116 (via base station 112) functions as the software provisioning device 124, however, no physical hardwire connection is necessary. The target update 102 (e.g. commands) is transmitted wirelessly to the GPS tracking device 104 and these commands provision the GPS tracking device 104. FIGS. 4 and 5 describe one embodiment of automated software provisioning.

Target update 102 may be stored in any storage medium within provisioning device 124 that is capable of storing computer readable data, including but not limited to volatile or non-volatile memory, hard drives, floppy disks, compact disks, digital video disks, or the like. The storage medium may also be located in a device that is external to, but accessible by, the provisioning device 124. It is further understood that the target update 102 may be coupled with automated executable files substantially similar to batch files.

The connection 106 may be any type of connection capable of linking the provisioning device 124 with the GPS tracking device 104. Examples of connection 106 include, but are not limited to, universal serial bus (USB), serial (RS232), parallel, network (TCP/IP), or any other connection as known to one skilled in the art. The connection 106 provides a communications path for wired communication. The connection 106 may also include part of a large-scale network, for instance, the Internet.

Though the embodiments described herein illustrate the provisioning of a GPS tracking device, other M2M devices (i.e., target device) may be provisioned according to the methods and system described herein. It is expressly understood that the GPS tracking device 104 (or other M2M device) may further include a plurality of sensors that may measure temperature, velocity, presence or absence of a particular element, or include other functionality for performing any other task.

Unlike conventional wireless devices, M2M devices generally do not have a user interface (UI) or a method for user data entry and these M2M devices may only have a power on or off mode. In addition, M2M devices are designed to automatically transmit data relating to a predefined set of criteria without user intervention, so M2M devices are generally designed without the ability to be easily configured by an end user.

The wireless network module 108 in the GPS tracking device 104 may utilize any wireless technology including, but not limited to, code division multiple access (CDMA), global system for mobile (GSM) communications, worldwide interoperability for microwave access (WiMAX), or any other wireless standard. Through the wireless network module 108 modem, the GPS tracking device 104 is able to communicate with other remote communication devices via an air interface.

One of the problems in setting up, operating, and updating the GPS tracking device 104 is that often times operating parameters for the device may need to be programmed or updated either prior to communication with remote communication devices or at some point in time thereafter. This requires special settings to be executed in a specific sequence. Because the GPS tracking device 104 does not include a UI or other conventional method of data entry, in order to provide it with updates, the GPS tracking device 104 is usually sent to a technician in order to have the target update 102 provisioned into the GPS tracking device 104. In situations where the GPS tracking device 104 cannot be transported to the technician, the technician must be deployed at the device's location. In both cases, there is considerable time, effort, and expense related to updating (provisioning) of the GPS tracking device 104.

The AMUS 100 overcomes these limitations by allowing for the secure updating through use of the target update 102 stored within the provisioning device 124. The target update 102 is downloaded or otherwise communicated to the GPS tracking device 104 through a wired connection (e.g., connection 106) or wireless connection (e.g., wireless network module 108) causing the execution of downloaded AT commands within the GPS tracking device 104 resulting in provisioning (updating). As described, the target update 102 may be deployed using either an automated hardware or software provisioning method.

Upon the connection 106 becoming active and the provisioning device 124 (including target update 102) and the GPS tracking device 104 being physically connected (in the automated hardware provisioning method), an update sequence may be initiated. This initiation may be automatically upon the connection 106 being physically made or may be initiated through the touch of a button after connection 106 has been made. This update sequence includes one or more predetermined sets of AT commands that exercise control of various aspects of the GPS tracking device 104. These predetermined AT commands perform maintenance, update, or configuration of the GPS tracking device 104 without requiring any interaction between a user and technician and the GPS tracking device 104. This allows for the rapid provisioning of the GPS tracking device 104 even without an initial setup of the device by a technician. The AMUS 100 promotes a touch less software configuration and update procedure.

This procedure applies similarly to automated software provisioning such that once a communication session is established between the GPS tracking device 104 and the host server 116 (as the provisioning device 124), the update sequence may be automatically or manually initiated by host server 116.

AS will be appreciated, the target update 102 may include provisioning information relating to the wireless access point nodes (APN), gateways (GW), domain name server (DNS) or other information that promotes wireless communication between the GPS tracking device 104 and a wireless network (not shown in FIG. 1). In some embodiments, the GPS tracking device 104 may be operable to communicate over a plurality of networks, gateways, and domains. It may be advantageous to have the GPS tracking device 104 operate on a specific network. In such an embodiment, the target GPS tracking device 104 will need to be programmed to interact with the wireless network. It is understood that prior to communication with the wireless network, some installation may be required. In such a case, the parameters that promote wireless communication between the GPS tracking device 104 and the wireless network will need to be programmed prior to wireless communication operation.

Now referring to FIG. 2, there is illustrated a system 200 that uses the automated hardware-provisioning device 124 to provision the GPS tracking device 104 (hardware provisioning). In this embodiment, the target update 102 is transmitted to the GPS tracking device 104 through the physical connection 106, implemented as a serial connection 202, between the provisioning device 124 and the GPS tracking device 104. It is understood that connecting the hardware-provisioning device 124 to the GPS tracking device 104 through the serial connection 202 will initiate hardware provisioning (or once connected, a button may active automatic provisioning).

Both the hardware provisioning device 124 and the GPS tracking device 104 include corresponding serial connection interfaces 202A, 202B. These serial connection interfaces includes various hardware (and may include firmware/software), such as logic circuitry and a controller, for implementing a serial connection operable using conventional AT commands. The design, implementation and functioning of this interface is readily known and understood by those of ordinary skill in the art.

In one example embodiment, the provisioning device 124 may include an attached small dongle device (not shown) that incorporates the serial interface and serial connection (e.g. USB, RS232, etc.). A microcontroller (not shown) may be incorporated into the design to manage processing logic required for executing the update to GPS tracking device 104. In this example embodiment, the provisioning device 124 (or the dongle device) may include one or more indicators, such as two LED lights (not shown) or a single bi-color LED (not shown). For instance, red and green LED devices may be used to provide feedback to a user (e.g., green for success, red for failure). The provisioning device (or dongle device) may include a plurality of buttons for specific purposes. For instance, in one configuration, the provisioning device 124 may have a single button for initiating the automated hardware provisioning process. In this manner, a user connects an electrical cable between respective interfaces on the provisioning device 124 and the GPS tracking device 104, presses the button, and the AMUS 100 automatically begins the hardware provisioning process. In another embodiment, the mere connection of the cable initiates the process. In other embodiments, more buttons may be added to correspond with different functionality (e.g., a first button for configuration, a second button for flash updates, etc.).

Now referring to FIG. 3, there is shown a flowchart illustrating a method 300 for performing an initial network setup update (target update) using the serial connection 202. Power is applied to the GPS tracking device 104 (step 302). This may be accomplished by pressing a power activation button and waiting for illumination of a light on the GPS tracking device 104, or may be performed through an activation switch located on the hardware provisioning device 124 after the communications cable is connected between the provisioning device 124 and GPS tracking device 104. Thereafter, the serial connection 202 is established with GPS tracking device 104 (step 304). This may be accomplished through the use of the AT command “ATE1V1”. This command ensures that the echo and verbose parameters are set on the GPS tracking device 104. If this parameter is not set, a microcontroller within the provisioning GPS tracking device 104 will be unable to interpret the responses from the GPS tracking device 104. If this command fails, the serial port and baud rate may be changed and the AT command retried. This step should cycle through all possible baud rates until an OK is returned to the provisioning device 124.

It will be understood that the GPS tracking device 104 will include hardware and software functionality therein (as described above) for implementing a serial connection and associated interface to function with AT commands. Utilization of AT commands through a serial connection allows a remote device to act as a master device and exert control over the slave device (such as GPS tracking device 104).

The provisioning device 124 transmits a command seeking verification of device manufacturer information and receives the requested information (step 306). This command may, in some embodiments, be “ATI”. This command initiates validation of a valid manufacturer platform. Logic within the provisioning device 124 checks for a specific string within the string returned, such as a company name or ID, against stored information (e.g., the device is identified as one that may be updated). If an invalid value is returned, a flash pattern may be displayed on the GPS tracking device 104 or the provisioning device 124 and the update process will be aborted.

The provisioning device 124 transmits a command to restore default settings for the GPS tracking device 104 (step 308). This AT command may be “AT&F”. If an error value is returned (e.g., an OK is not returned by the GPS tracking device 104), a flash pattern may be displayed on the GPS tracking device 104 or the provisioning device 124 and the update process will be aborted. As will be appreciated, this step may be optional or unnecessary in the event updates are accomplished piecemeal (i.e., only a specific portion of the device operating parameters are changed instead of global resetting of all operating parameters).

The provisioning device 124 transmits a command to write the update data to the GPS tracking device 104 (step 310). This AT command may be “AT&W”. This step issues the write command to transfer updated operating parameters (in this example, firmware) to memory in the GPS tracking device 104. If an invalid value is returned, a flash pattern may be displayed on the GPS tracking device 104 or the provisioning device 124 and the update process will be aborted.

The provisioning device 124 transmits a command querying the GPS tracking device for device identification information for verification purposes (step 312). A query string is transmitted to obtain device identification data, such as the International Mobile Equipment Identity (IMEI) information, MAC address or ESN information, and the like. The AT command used to perform this process may be “AT+CGSN”. The IMEI is a unique number assigned to every GSM device and stored therein. In response, the GPS tracking device 104 sends the device identification information to the provisioning device 124, which is used as a validity check by comparing the device identification data to stored data identifying those devices for which the target update 102 is valid. This allows the provisioning device to ensure that target update 102 which it is performing (provisioning) is applied to the correct GPS tracking device(s) 104. For example, a given provisioning device 124 may be used to provision multiple GPS tracking devices 104, such as those owned or used by a specific user or associated with a particular purpose or function. If an invalid value is returned, a flash pattern may be displayed on the GPS tracking device 104 or the provisioning device 124 and the update process will be aborted. It will be understood that the device identification data associated with the target update 102 (identifying the device that should be receiving the update) may be alternatively downloaded to the GPS tracking device 104, which performs the compare against its stored data to determine a match.

As will be appreciated, this step may be performed at an earlier stage in the method 300′, such as at the time the device manufacturer is verified or otherwise before update data is transferred to the GPS tracking device 104.

The provisioning device 124 transmits a command to set a device identifier for the GPS tracking device 104 (step 314). This may include using the AT command “AT$MDMID-Value from +CGSN query” to program a device identifier. This AT command sets the GPS tracking device 104 with a unique or special device identifier (stored therein). The device identifier is used to identify the GPS tracking device 104 for communication and/or further programming through the wireless network via a web application (e.g., hosted on the server 116). The device identifier is normally used to identify the device during initial communications or reporting. In addition, once the device identifier is reported to the web application, the user can change the value used for identification. If an invalid value is returned, a flash pattern may be displayed on the GPS tracking device 104 or the provisioning device 124 and the update process may be aborted.

The provisioning device 124 transmits one or more commands to set other parameters for the GPS tracking device 104 (step 316). This may include issuing commands that set the addressing and reporting parameters used with the web application. The reporting address (where to report) is set using the “AT$FRIEND” command (e.g., the address of the server 116. The reporting frequency may be set with the “AT$WAKEUP” and “AT$ACKTM” commands. If an invalid value is returned, a flash pattern may be displayed on the GPS tracking device 104 or the provisioning device 124 and the update process may be aborted. It is understood that this may further comprise saving the commands to the GPS tracking device 104 after they have been received.

The provisioning device 124 transmits one or more commands to reset or reboot the GPS tracking device 104 (step 318). This may include the AT commands “AT&W” and/or “AT$RESET”. This step issues commands that write parameters to non-volatile memory and reset target GPS tracking device 104. These parameters include any which have been discussed above, or other parameters related to the operation of target GPS tracking device 104. This insures that the modem has been configured appropriately and that the platform is in a known state of operation. If an invalid value is returned, a flash pattern may be displayed on the GPS tracking device 104 or the provisioning device 124 and the update process may be aborted. If everything has proceeded properly, a green LED flashes to indicate a successful initialization or programming session.

It is expressly understood that in this example, and the example shown in FIG. 5, there is no requirement that the steps be followed in the order described. It is further understood that other AT commands may be used to perform substantially the same functions as those disclosed herein.

Though the method 300 is described with respect to initial hardware provisioning of network setup parameters and certain device operating parameters, other upgrades (provisioning) may be performed, such as the times and frequency for GPS information to be transmitted, the minimum number of satellites that the GPS tracking device 104 requires in order to obtain a position fix, as well as other operating device parameters for the target device. Moreover, firmware, software and other hardware updates may be performed. For these other types of updates, only steps 304 and 310 (with multiple commands being issued) might not be necessarily performed. Alternatively, one or more of the other steps (306, 312, 314, and 316) may also be performed.

Now turning to FIG. 4, there is illustrated a system 400 that uses the automated software-provisioning device 124 (in the form of the server 116) to provision the GPS tracking device 104 through a wireless connection (software provisioning). In this embodiment, the target update 102 is transferred (or applied) from the provisioning device 124 to the GPS tracking device 104 through a wireless network 406. The target update 102 is generated or selected though a provisioning user interface (UI) 402 associated with the server 116. In this embodiment, the provisioning UI 402 may be embodied as a web interface that can provide input/output access to the server 116 and the target update 102. The provisioning UI 402 enables a user to input, generate, select and/or modify the target update 102 through a combined browser and associated service interface. The target update 102 is transmitted (or applied) through the provisioning server 404 and then through the wireless network 406 to the GPS tracking device 104. In this example, the GPS tracking device 104 already has some level of connectivity with the wireless network 406. This method provisions the GPS tracking device 104 without the use of a remote provisioning device requiring a serial cable. In other words, with some minimal level of wireless connectivity between the GPS tracking device 104 and the server 116, the GPS tracking device 104 can be provisioned through the wireless path.

It is understood that a serial connection may be simulated through wireless network 406 using a parallel connection. This serial connection ensures that commands are processed in a specific order, regardless of the order that packets arrive to or from the target GPS tracking device 104. Through a simulated serial connection, the integrity of target update 102 is protected. Using a protocol wrapper at both the provisioning server 404 and the GPS tracking device 104 may create this serial connection. The protocol wrapper simulates a serial connection by adding order specific information to the parallel data, allowing for the reconstruction of the serial information at either the server 116 or the GPS tracking device 104. Unlike a parallel connection, data commands are only executed in a specific order, and therefore the serial connection is required to ensure the proper execution of commands.

Now referring to FIG. 5, there is shown a flowchart illustrating a method 500 for performing software provisioning of the target update. In one embodiment, server 116 pushes target update 102 to the GPS tracking device 104. This pushing may be done at a particular time, or after a request is received GPS tracking device 104. When a connection is established to perform the update, the identification number of the GPS tracking device 104 is compared against a known database, if there device matches an entry in the database indicating an update is available, the update process begins. It is understood that server 116 receives GPS tracking device 104 device information prior to actually initiating an update. This prevents a device from being programmed with the wrong information, which could render the GPS tracking device 104 unusable.

In FIG. 5, the GPS tracking device 104 is registered for a wireless service (step 502). The user of the GPS tracking device 104 is required to complete registration for access to the solution. Customer account and billing information is collected. The user logs into service and provides programming details (step 504). This information related to device information and the features that the user wishes to use on the device. Data to be sent to the GPS tracking device 104 is queued (step 506). The SIM toolkit (STK) application or data for the application is queued to send to mobile devices. It is further understood that rather than a STK application, SMS messages or any other scheme of transferring information may be used. The STK may also push information relating to the determination of the GPS tracking device 104 position, parameters for frequency of reporting by the GPS tracking device 104, as well as information to be reported by the GPS tracking device 104.

Two parameters may be needed to be programmed into the GPS tracking device 104. They include the APN programmed using the attention command “AT+CGDCONT” and the destination IP address used for data reporting. Once these parameters are programmed, the device will use the Internet Protocol (IP) to communicate any additional changes for the device.

A determination is made as to if the STK application has been sent (step 508). If the STK application has not been sent, the STK application will be pushed to the device (step 510). Additionally, the application could be programmed on to the SIM card at manufacturing time thus eliminating this step. If the STK application has been sent, data will be pushed to the platform (step 512). This data will be provisioning information input from the user interface. It is understood that this data may be pushed in the form of SMS messages, GSM data, or any other form of wireless communication. The server 116 checks to see if the device is online (step 514). If the device is online, data is sent to the GPS tracking device (step 516). Once the data has been sent to the GPS tracking device 104, the GPS tracking device 104 processes the data (step 518).

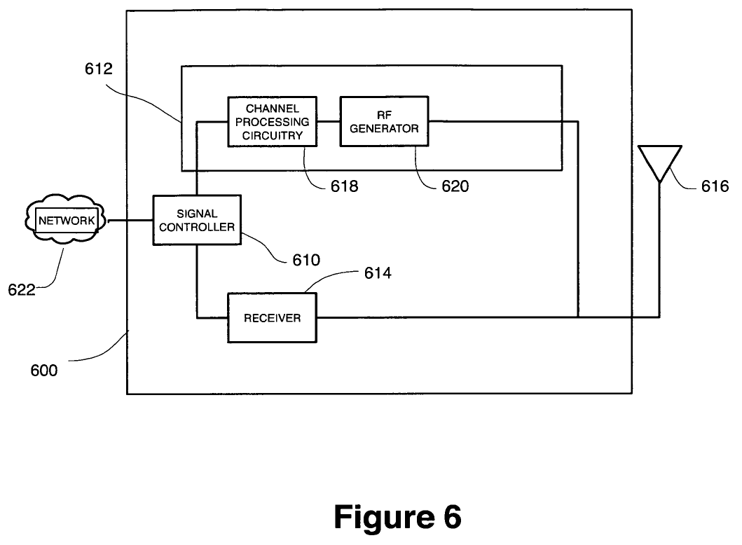

As shown in FIG. 6, the wireless network 406 may transmit data through a base station 600. The base station 600 is a medium to high-power multi-channel, two-way radio in a fixed location. Typically low-power, single-channel, two-way radios or wireless devices such as mobile phones, portable phones and wireless routers may use it. The base station 600 may include a signal controller 610 that is coupled to a transmitter 612 and a receiver 614. The transmitter 612 and the receiver 614 (or combined transceiver) is further coupled to an antenna 206. In the base station 600, digital signals are processed in a channel processing circuitry. The digital signals may be signals for a wireless communication system, such as signals that convey voice or data intended for a mobile terminal (not shown). The base station 280 may employ any suitable wireless technologies or standards such as 2G, 2.5G, 3G, GSM, IMT-2000, UMTS, idem, GPRS, 1xEV-DO, EDGE, DECT, PDC, TDMA, FDMA, CDMA, W-CDMA, LTE, TD-CDMA, TD-SCDMA, GMSK, OFDM, WiMAX, the family of IEEE §802.11 standards, the family of IEEE §802.16 standards, IEEE §802.20, etc. The signal controller 610 then transmits the digital signals to the transmitter 612, which includes the channel processing circuitry 208. The channel processing circuitry 208 encodes each digital signal, and a radio frequency (RF) generator 210 modulates the encoded signals onto an RF signal. The resulting output signal is transmitted over the antenna 206 to the mobile terminal (e.g., the GPS tracking device 104). The antenna 206 also receives signals sent to the base station 600 from the mobile terminal. The antenna 206 couples the signal to the receiver 614 that demodulates them into digital signals and transmits them to the signal controller 610 where they may be relayed to an external network 212. The base station 600 may also comprise auxiliary equipment such as cooling fans or air exchangers for the removal of heat from the base station 600.

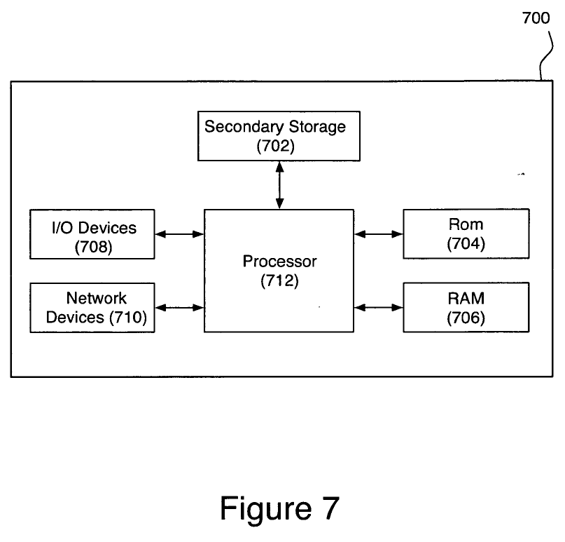

Now referring to FIG. 7, there is shown a block diagram of the server 116 described above which may be implemented as a general-purpose computer 700 (or web server) with sufficient processing power, memory resources, and network throughput capability to handle the necessary workload placed upon it. FIG. 7 illustrates a typical, general-purpose computer system suitable for implementing one or more embodiments disclosed herein. The general-purpose computer 700 includes a processor 712 (which may be referred to as a central processor unit or CPU) that is in communication with memory devices including secondary storage 702, read only memory (ROM) 704, random access memory (RAM) 706, input/output (I/O) 708 devices, and network connectivity devices 710. The processor may be implemented as one or more CPU chips.

The secondary storage 702 is typically comprised of one or more disk drives or tape drives and is used for non-volatile storage of data and as an over-flow data storage device if RAM 706 is not large enough to hold all working data. Secondary storage 702 may be used to store programs that are loaded into RAM 706 when such programs are selected for execution. The ROM 704 is used to store instructions and perhaps data that are read during program execution. ROM 704 is a non-volatile memory device that typically has a small memory capacity relative to the larger memory capacity of secondary storage. The RAM 706 is used to store volatile data and perhaps to store instructions. Access to both ROM 704 and RAM 706 is typically faster than to secondary storage 702.

I/O 708 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 710 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 710 may enable the processor 712 to communicate with an Internet or one or more intranets. With such a network connection, it is contemplated that the processor 712 might receive information from the network, or might output information to the network in the course of performing the above-described method steps. Such information, which is often represented as a sequence of instructions to be executed using processor 712, may be received from and outputted to the network, for example, in the form of a computer data signal embodied in a carrier wave.

Such information, which may include data or instructions to be executed using processor 712 for example, may be received from or transmitted to the network, for example, in the form of a computer data baseband signal or signal embodied in a carrier wave. The baseband signal or signal embodied in the carrier wave generated by the network connectivity devices 710 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 712 executes instructions, codes, computer programs, scripts that it accesses from hard disk, floppy disk, optical disk (these various disk based systems may all be considered secondary storage 702), ROM 704, RAM 706, or the network connectivity devices 710.

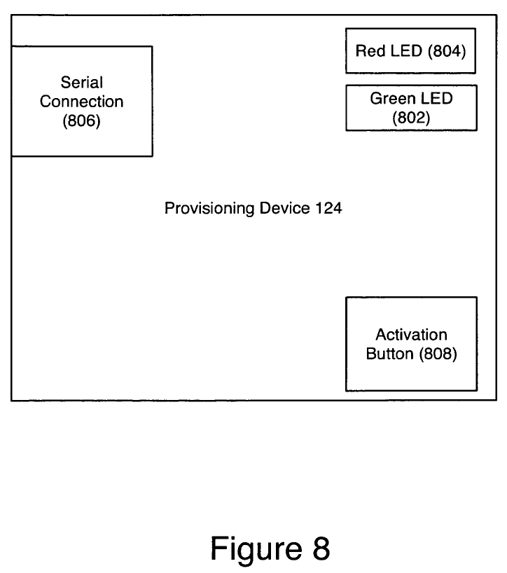

FIG. 8 is an example of hardware provisioning device 124. In this example, hardware provisioning device 124 is shown with a single activation button 808, green light emitted diode (LED) 802, red LED 804, and serial connection 806. The activation button 808 is a simple push button that is used to initiate provisioning after the hardware provisioning device 124 is connected to the target GPS tracking device 104. Serial connection 806 is shown as a port, however, it is understood that any type of connection (e.g., USB, IR, RS232, etc.) could be used. It is further understood that no power is shown in FIG. 8, but an additional power source may be required for hardware provisioning device 124 depending on the hardware within hardware provisioning device 124.

GPS tracking device 104, while described as a GPS tracking device, could be any type of device that provides functionality including tracking, monitoring, measuring, or obtaining any data element. GPS tracking device 104 may, in some embodiments, a device that obtains position information from source other than satellites, and may provide information other than position information.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

We claim:

1. A GPS tracking system, comprising:
a position monitoring device having a wireless communication modem and a first serial port;
a serial connection coupled to the position monitoring device through the first serial port; and
a provisioning device coupled to the serial connection through a second serial port, wherein the provisioning device comprises a memory with a target update, and a processor, wherein the provisioning device is coupled to the position monitoring device through the serial connection using the second serial port, wherein the provisioning device initiates a configuration of the wireless communication modem using the target update, and wherein the target update comprises at least one attention command.

2. The system of claim 1, wherein the serial connection is a universal serial bus (USB) connection.

3. The system of claim 1, wherein the position monitoring device is a machine to machine device, and wherein the machine to machine device is operable to transmit at least one data element to at least one remote location.

4. The system of claim 1, wherein the attention commands are issued in a predetermined sequence.

5. The system of claim 1, wherein the at least one attention command is used to configure the destination gateway of the wireless communication modem.

6. The system of claim 1, wherein the wireless communication modem is configured to operate using the global system for mobile (GSM) standard.

7. The system of claim 1, wherein the target update further comprises a hardware switch, wherein the switch configures the configuration mode of the target update.

8. The system of claim 1, wherein the target update is configured to provide a firmware update to the position monitoring device.

9. An apparatus, comprising:
a memory that stores a plurality of commands to configure a wireless modem;
a processor that accesses the memory to execute the plurality of commands to configure the wireless modem; and
a serial port, wherein the serial port is used to connect to the wireless modem, wherein the serial port detects the connection of a target device to the serial port, and wherein the serial port is used to automatically configure the target device using the plurality of commands stored in the memory executed by the processor.

10. The apparatus of claim 9, wherein the serial port is a RS232 port.

11. The apparatus of claim 10, wherein the configuration of the target device is preformed through attention commands.

12. The apparatus of claim 9, wherein the memory is removable flash memory.

13. The apparatus of claim 9, wherein the wireless modem is integrated into the apparatus.

14. The apparatus of claim 9, further comprising a global positioning system (GPS) unit.

15. A method of configuring a wireless modem, comprising:
connecting a target device to an update device;
applying power to the target device, wherein the target device comprises a wireless modem, and wherein the target device does not have a user interface;
verifying the manufacturer of the target device;
restoring the default settings to the target device;
storing configuration data on the target device; and
rebooting the target device.

16. The method of claim 15, wherein the configuration data comprises the at least one internet gateway address and one domain name server.

17. The method of claim 15, further comprising querying the target device International Mobile Equipment Identity.

18. The method of claim 15, further comprising initiating an internet connection between the target device and a server through the wireless modem.

19. The method of claim 15, further comprising updating the target device firmware.

20. The method of claim 15, further comprising verifying the target device settings.
